(19) United States
(12) Patent Application Publication
(10) Pub. No.: US 2026/0336450 A1
(43) Pub. Date: Oct. 29, 2026

(54) MOBILE DISCHARGING DEVICE AND METHOD FOR DISCHARGING A BATTERY

(71) Applicant: Robert Bosch GmbH, Stuttgart (DE)

(72) Inventor: Jens Konczak, Reppenstedt (DE)

(21) Appl. No.: 19/111,412

(22) PCT Filed: Aug. 31, 2023
(86) PCT No.: PCT/EP2023/073872

§ 371 Date: Mar. 13, 2025

(30) Foreign Application Priority Data
Sep. 15, 2022 (DE) 10 2022 209 663.0

(51) Int. Cl. B60L 53/57; B60L 53/16; B60L 53/30; B60L 53/302; B60L 53/62; B60L 53/65; B60L 53/66; B60L 53/68; H02J 7/60; H02J 7/90

(52) U.S. Cl. CPC B60L 53/57; B60L 53/16; B60L 53/302; B60L 53/305; B60L 53/62; B60L 53/65; B60L 53/66; B60L 53/68; H02J 7/685; H02J 7/933

(57) ABSTRACT

The invention relates to a mobile discharging device (200) for the targeted controlled discharging of a battery (130) of a unit (100), in particular an electric vehicle, comprising said battery, a second-life application or a mobile or stationary electricity store, such as a PV system,

comprising the following components
a connection
a transmission device (230) for sending and receiving signals
an evaluation device (220) comprising intelligent evaluation electronics and at least one integrated storage medium, wherein the intelligent evaluation electronics are configured to decrypt and interpret a signal,
an energy supply (240),
an internal energy consumer (250), and
a control device (260) for the drawn energy, in particular as overload protection.

### BACKGROUND

The present invention relates to a mobile discharging device, a method for the targeted discharging of a battery, and a battery discharge system according to the disclosure.

Electric vehicles require periodic charging. In accident, transport, repair, or scrapping situations, the partially or fully charged traction or drive batteries pose a safety hazard. Especially if they have undetected defects, they can cause significant damage ranging from thermal development, up to fires. Before recovering, removing, or repairing a vehicle after an accident, the battery should be discharged for safety reasons. Likewise, partially or fully charged batteries pose an increased risk for specific transport situations, such as air or sea freight. Again, transporting with a discharged battery significantly minimizes the risk. It is therefore desirable to be able to discharge batteries in a targeted and mobile manner at the location of need to accommodate these situations.

Electric vehicles require an internal energy source to operate their electric motor; this is implemented as a battery. The battery may be charged via a connection to an external power supply system or may be used bidirectionally to supply power to that power supply system.

Methods are known from the prior art, for example, the bidirectional use of the traction battery as an energy store for photovoltaic (PV) systems and feeding power back into the domestic power grid. Here, the electricity from the traction battery previously fed in via the charging cable from the in-house stationary PV system is fed back into the domestic power grid as needed (e.g., at night).

DE 102016214484 A1 discloses a method for preparing a battery of a motor vehicle comprising a plurality of lithium-ion battery cells for transportation, in which a predetermined charge state of the battery is set, in which the built-in battery delivers electrical energy to at least one electrically connected energy sink (e.g., consumer of the on-board power system) of the motor vehicle. No external devices are connected to the battery.

DE 102020004733A1 describes a method for operating a vehicle-based energy storage system, which is at least temporarily coupled to an external power grid, comprising at least one vehicle with a battery and a charging station for charging and/or discharging the battery of the vehicle via the external power grid.

DE 102018114239 A1 discloses a vehicle with an accumulator and a coil arrangement bidirectionally operatively connected to the accumulator for charging the accumulator in a first operating state and discharging it in a second operating state. A corresponding vehicle-station arrangement can be integrated into a suitable section of a road or parking lot.

### SUMMARY

In contrast, the present invention provides a mobile discharging device, a method for the targeted discharging a battery using this device, and a battery discharging system with the characterizing features of the disclosure.

According to the present invention, a mobile discharging device is provided for the targeted controlled discharging of a battery of a unit comprising said battery. This unit is, for example, an electric vehicle, a second-life application, a store comprising multiple batteries or battery cells, or a mobile or stationary electricity store, such as a PV system. The mobile discharging device comprises the following components: a connector, a transmission device for sending and receiving signals, an evaluation device comprising intelligent evaluation electronics and at least one integrated storage medium, wherein the intelligent evaluation electronics are configured to decrypt and interpret a signal, a power supply, an internal energy consumer, and a control device for the drawn energy, in particular as overload protection.

In the context of this invention, all types of motor vehicles that are electrically or at least partially electrically operated, so-called hybrid vehicles, are referred to as an electric vehicle. Electrically or partially electrically powered cars, trucks, buses or watercraft are therefore referred to in particular as electric vehicles. Alternatively, an electrically or partially electrically operated aeronautical application is also conceivable.

The evaluation device comprising the intelligent evaluation electronics with at least one integrated storage medium is capable of enabling access to a particular software or data when predetermined conditions occur, such as exchanging a particular protocol, receiving and sending a specific signal or data, in particular a digital key or digital signature. The at least one storage medium stores target values and/or standard values of various parameters, such as the charge state, the discharge state, the voltage value, and/or the temperature value of the battery to be discharged. In addition, optimal discharge curves may be stored for different applications, for example for rapid discharge. Routines may also be stored that initiate a control unit of a unit comprising a battery to provide power bidirectionally.

The signal to be detected is, for example, a voltage value, in particular of a high-voltage line, a change in the voltage value of the live component, or a dataset, for example, of the control unit of the unit comprising the battery.

The power supply of the discharging device is realized, for example, as an internal battery of the discharging device, which for example is supplied with energy from the battery to be discharged in the unit comprising said battery. Alternatively, the power supply of the discharging device is realized as a mains connection to an external power grid.

The internal power consumer of the discharging device acts as an energy dissipator. In particular, it transfers the current from the battery to be discharged to other power consumers, in particular to external heating elements or in the form of feedback into an external power network. If no other power consumers are present, in particular at an accident site, heated cooling water from a cooling device of the discharging device can be released on-site onto the road or grassland, for example.

In the context of this invention, a discharging device is understood to be a mobile device. Alternatively, it can also be stationary, for example, detachably mounted on the wall of a repair workshop.

For example, the discharging device comprises a connecting cable for connecting the connector of the mobile discharging device to the connection point of the unit comprising the battery to be discharged.

In this case, the connecting cable can be rigidly connected to the discharging device or designed to be plugged into it. As a plug-in design, it is, for example, a standard charging cable for electric vehicles. Furthermore, the connection cable is designed, for example, in a form that allows connection to other live components, such as high-voltage components of an electric vehicle or a mobile and stationary electricity store of a PV system. This is used, for example, when the charging socket is no longer usable due to damage, or when the unit comprising the battery, in particular the electric vehicle, is not designed for bidirectional current flow, or when it is a single battery to be discharged, for example in a store with many batteries.

For example, to move an electric vehicle or operate a stationary second-life application, the discharging device must first be removed. To ensure this is not forgotten and to prevent damage to the electric vehicle or the stationary second-life application, the mobile discharging device and, for example, the connecting cable, it is not possible to drive or operate with the discharging device plugged in.

An advantage of the mobile discharging device according to the invention is that the battery of the unit containing said battery can be discharged by means of the mobile discharging device in a targeted and controlled manner on-site, regardless of its location. If the unit comprising the battery is an electric vehicle, for example, the battery can be discharged or partially discharged directly on-site if the vehicle is damaged due to an accident, needs to be recovered, and is to be removed. Similarly, during a workshop visit, for example when replacing the traction battery, it can be discharged or partially discharged in the workshop by means of the discharging device. In a further aspect for transporting the battery, it is prepared on-site by means of the discharging device for transport situations, such as air freight or shipping, in which safe transport is only possible with a discharged or partially discharged battery. In this way, for example, the risk of thermal runaway in the battery, in particular in the event of undetected defects, and a possible associated fire can be minimized or eliminated, ensuring safe handling of the battery for humans and the environment.

Thus, it is advantageous for the mobile discharging device to comprise an internal cooling device for cooling by means of air and/or a liquid cooling medium, in particular water. As the transfer of power from the battery to the discharging device generates heat, a cooling device is preferred. This allows the battery to be discharged much faster.

In one embodiment, for example, the cooling medium circulates within a closed loop located inside the discharging device. In this case, the cooling medium can be supplied externally to a cooling medium connection of the circuit or stored in the discharging device.

In an alternative embodiment, the cooling circuit is located at least partially externally, i.e., outside the discharging device, and can be open or closed. The cooling medium can be connected externally via a cooling device connection, for example. For example, the cooling device connection is realized as a Storz coupling, as is common in fire departments, so that water from a fire truck or a fire hydrant can serve as the cooling medium. Alternatively, the cooling device connection is realized as a standard household water connection, so that, for example, a faucet or a garden hose can be connected.

If the discharging device is used in a workshop or other building, for example, the cooling device can be connected to the circuit of a building air conditioner or to a heating circuit, for example. The resulting heat can also be used to heat water and/or feed the heating circuit.

Alternatively or additionally, the cooling medium is, for example, air, which is circulated by means of fans in the cooling device. In this case, the fans are powered by energy from the battery to be discharged. Alternatively, the cooling medium can be oil.

Additionally, it is advantageous for the cooling device to have temperature-controlled flow regulation. This allows for control and/or regulation of the cooling medium's inflow and/or the speed at which the cooling medium circulates. For example, the temperature-controlled flow regulation and the evaluation device of the discharging device communicate with each other, in particular if an adjustment to the discharge rate of the battery is necessary, for example due to excessive heating of the mobile discharging device.

According to another advantageous embodiment, the mobile discharging device comprises a display device via which a discharge state and/or a charge state and/or a battery voltage and/or a temperature of the battery to be discharged and/or a cooling water temperature and/or a signal light can be displayed.

If the display device comprises a signal light, it shows a green light, for example, when the battery of the unit containing said battery has been fully discharged or discharged to a predetermined and/or set discharge state, charge state, and/or voltage value. As long as this state or value is not reached, the signal light illuminates red, for example. Alternatively or additionally, the display device is realized as a display that shows the corresponding values and information.

Using such a display device, the user of the discharging device is shown, for example, whether the discharging process of the battery has already started, is still ongoing, paused, or has already ended. Furthermore, for example, the remaining duration of the battery discharge and/or the current discharge state, charge state, voltage value, and/or temperature value of the battery and/or the discharging device is displayed. Thus, a user can estimate and plan the duration of the battery discharge, as well as manually intervene, if necessary, to stop the discharge earlier or to make it last longer or pause it. Additionally, a user can see, for example, if the battery discharge is not proceeding as planned or if a value is not correct, so that the user can stop, pause, adjust, and/or restart the battery discharge.

Furthermore, it is advantageous if the evaluation device of the mobile discharging device has a means for enabling the transmission of information regarding the battery and/or the unit comprising the battery. Such information includes, for example, the discharge state, such as a voltage value, a discharge duration, or a remaining discharge time until reaching a set target value, for example. Furthermore, such information can be a location, in particular a GPS (Global Positioning System) location and/or a chassis number in case the unit comprising the battery is an electric vehicle.

For example, the means for enabling transmission of information relating to the unit comprising the battery may include program code which controls a controller so that it sends a signal to a transmission unit, in particular an antenna and its control unit, whereupon said control unit transmits the information, for example vehicle information, relating to the unit comprising the battery, in particular the electric vehicle.

Advantageously, in the event of an accident involving an electric vehicle, the discharge state and the remaining time until the target value is reached, the temperature and other information relating to the battery can be displayed to the emergency services, for example on a mobile device such as a cell phone, when the battery is being discharged by means of the mobile discharging device. For example, emergency services can quickly check and adjust the target values if necessary.

The invention further relates to a method for the targeted controlled on-site discharging of a battery in a unit comprising said battery using a mobile discharging device. The unit comprising the battery is, for example, an electric vehicle, a second-life application, or a mobile or stationary electricity store such as a photovoltaic system. The method comprises the following steps:
Connecting the connection of the mobile discharging device to the connection point of the unit comprising the battery to be discharged, in particular via a connecting cable.
Detecting a connection between the unit comprising the battery and the mobile discharging device at least by means of the intelligent evaluation electronics of the evaluation device of the mobile discharging device by detecting a signal.
Discharging the battery of the unit, wherein energy is drawn from the battery and supplied to the mobile discharging device.

Such a method is characterized in that the battery of the unit comprising said battery can be discharged or partially discharged in a targeted and controlled manner on-site by means of the method according to the invention with the aid of the mobile discharging device, regardless of where the location is.

Furthermore, the advantages already described above for the discharging device apply.

In an advantageous embodiment of the method according to the invention, before, during, or after step b) or step c), a data exchange with the unit comprising the battery takes place to initiate a bidirectional current output of the battery or to simulate the output to a domestic power grid by means of stored standard routines.

In a preferred advantageous embodiment of the method according to the invention, before, during, or after step a) or step b), a cooling medium for a cooling device of the discharging device is additionally connected via a cooling device connection.

The advantages described above for the mobile discharging device with cooling device apply.

According to a first advantageous embodiment, the connection point of the unit comprising the battery is a charging socket into which a connecting cable with a plug can be inserted to connect the unit to a discharging device according to the invention. Such a connection can be implemented via a standardized type 2 plug and socket pair, for example. The method according to the invention is initiated, for example, by manual insertion.

Advantageously, if the unit comprising the battery is an electric vehicle, its charging cable can be used for connection to the electric vehicle and the discharging device, which is already available in the electric vehicle. Alternatively, a different connecting cable is used.

In a further advantageous embodiment of the method according to the invention, in step b) of the method, the detection of the connection between the unit comprising the battery and the mobile discharging device is also detected by the control unit of the unit comprising the battery.

Advantageously, the unit comprising the battery and the electric vehicle can communicate with each other in this way.

According to an advantageous further development, step b) is followed by step b′), in which communication with the control unit of the unit comprising the battery is initiated by the detected connection, and a specification is made by the discharging device, in particular by the evaluation device with intelligent evaluation electronics of the discharging device, to the control unit of the unit comprising the battery in particular by simulating or initiating an internal vehicle routine indicating that current should be fed back into a power grid, for example into a domestic power grid.

The evaluation device of the discharging device evaluates the signals from the control unit or the on-board computer of the unit comprising the battery and specifies that energy should be drawn from the battery. The evaluation device of the discharging device then starts discharging the battery, for example.

In addition, it is advantageous if step b′) is followed by step b″), in which communication between the control unit of the unit comprising the battery and the evaluation device of the discharging device is ended.

In a second advantageous embodiment, the connection point of the unit comprising the battery is a live component. This may be, for example, a high-voltage component of an electric vehicle. The connection to a live component is made, for example, via suitable contact options or other contact points contact available on the vehicle in the case of an electric vehicle.

Advantageously, the battery can also be discharged if, for example, the charging socket of an electric vehicle is no longer usable due to damage or the unit comprising the battery, in particular the electric vehicle, is not designed for bidirectional current flow.

According to a further advantageous embodiment, the signal in step b) is a voltage value of a high-voltage line or a change in the voltage value of the live component of the battery or the unit comprising the battery.

Advantageously, the intelligent evaluation electronics of the evaluation device of the discharging device detect a connection to the unit comprising the battery or other live components in this way without the need for communication with the unit comprising the battery.

In a further advantageous embodiment, it is provided that the intelligent evaluation electronics of the evaluation unit of the discharging device automatically start discharging the battery after detecting the connection to the unit comprising the battery. Alternatively, discharging the battery starts after approval from an operator.

Advantageously for these options, battery discharge may take place without the battery having to have a functioning communications connection to the unit 100 comprising said battery. This allows uninstalled batteries to be discharged in a store or during transportation, for example.

Thus, batteries from special vehicles can also be discharged, regardless of whether they are installed in the special vehicles or located in a charging station or battery store.

Another advantage is that mobile and stationary electricity stores can be discharged in the same manner.

Furthermore, it is advantageous if state information of the battery and/or individual battery cells of the battery, such as a discharge state and/or a charge state and/or a voltage value and/or a discharge capacity and/or an energy output and/or a thermal state of the battery, in particular a temperature of the battery, is transmitted from the evaluation device of the discharging device to the unit comprising the battery and/or to other receivers such as to mobile devices of users like service technicians or emergency services at the scene of an accident.

The thermal state, in particular the temperature of the battery of the unit comprising said battery, can be determined directly, for example by means of at least one temperature sensor, or indirectly, for example via a voltage value. If the battery becomes too warm due to the discharging process, it can damage itself or the unit comprising said battery due to the heat generated. In some cases, a smoldering fire or an open fire may even occur.

Determining the thermal state and in particular the temperature of the battery and communicating the corresponding state information of the battery can advantageously be used to detect heat generation early and mitigate the risk of damage from a fire by reducing, pausing or stopping the discharge. For electric vehicles in particular, it is therefore of great interest to know the thermal state of the battery.

In addition it is advantageous if the state information of the battery and/or the battery cells is transmitted at arbitrarily adjustable intervals during the discharge process.

As a result, a defect that arises only during the discharging process, in particular a defect of the battery or portions thereof, for example, can also be detected early. In this way, regular monitoring of the battery is possible. This allows the battery to be optimally discharged without causing damage.

In one embodiment, it is advantageous if information from the unit comprising the battery, in particular its GPS location, and/or if the unit comprising the battery is an electric vehicle, the chassis number, is sent to a receiver, such as a user's mobile terminal device. For example, users may be service personnel or emergency services.

By transmitting the location and/or the chassis number, the user, owner, or operator of an electric vehicle can monitor important vehicle data and, if necessary, change target values or make other parameter adjustments.

Furthermore, it is advantageous when the information of the unit comprising the battery, as well as battery state information such as charge state and/or voltage value and/or discharge capacity and/or energy output and/or thermal state of the battery, in particular the battery temperature, are transmitted via a radio network, in particular a Wide Area Network (WAN) or a Global System for Mobile Communications (GSM) network.

Advantageously, information from the battery or the unit comprising the battery can be transmitted to any location with a connection to the respective radio network. The method can thereby also be coordinated remotely. Both WAN and GSM technology and GPS locating technology are standardized and can be easily used by the discharging device.

The network can further extend across a region, for example a city, a particular terrain, particularly plant premises, a single building, for example a showroom or exhibition hall, or a large area, particularly the planet, as well as all transportation routes by land, sea and air. Furthermore, the network can be locally restricted and limited by a local area network (LAN), in particular a wireless local area network (WLAN).

In a further particularly advantageous embodiment, discharging in step c) is paused or ended when a predetermined threshold value of the discharge state and/or charge state and/or voltage value and/or temperature value of the battery to be discharged is reached.

For example, the respective parameter, in particular the discharge state and/or charge state and/or the voltage value and/or the temperature value of the battery to be discharged has a target value which, for instance, forms a threshold value. The intelligent evaluation electronics of the evaluation unit monitor whether a measured value is within a specific measurement range or whether the value is above or below a threshold value and, if necessary, initiate appropriate measures, such as ending or pausing the discharge process of the battery. For example, a threshold value for the charge state of the battery is 10%. At this charge state, the discharging process is stopped. In this way, an optimal charge or discharge state of the battery can be achieved, in particular for subsequent transport of the battery and/or the unit comprising said battery.

A third subject of the present invention is a battery discharging system comprising a battery in a unit comprising said battery and a mobile discharging device. In this regard, the unit comprising the battery and the mobile discharging device can be connected to each other, in particular via a connecting cable, so that electrical energy can be transferred from the battery of the unit comprising said battery to the discharging device in a targeted and controlled manner, in particular by means of the method according to the invention. The unit comprising the battery is in particular an electric vehicle, a second-life application, or a mobile or stationary electricity store such as a PV system.

The unit comprising the battery, in particular the electric vehicle, advantageously comprises evaluation electronics or a control unit or an on-board computer designed to determine at least one piece of state information about the battery, such as a battery charge state or a signal, for example indicating that the battery and the electric vehicle are ready for power recovery. For example, the evaluation electronics of the electric vehicle can be implemented as part of the on-board software of the on-board computer of the electric vehicle, or as an additional module in the electric vehicle and/or in its battery.

### BRIEF DESCRIPTION OF THE DRAWINGS

Advantageous exemplary embodiments of the present invention are shown in the drawing and explained in more detail in the subsequent description. Shown are:

FIG. 1a: a schematic illustration of a battery discharging system according to a first embodiment of the present invention, and

FIG. 1b: a schematic illustration of a battery discharging system according to a second embodiment of the present invention.

### DETAILED DESCRIPTION

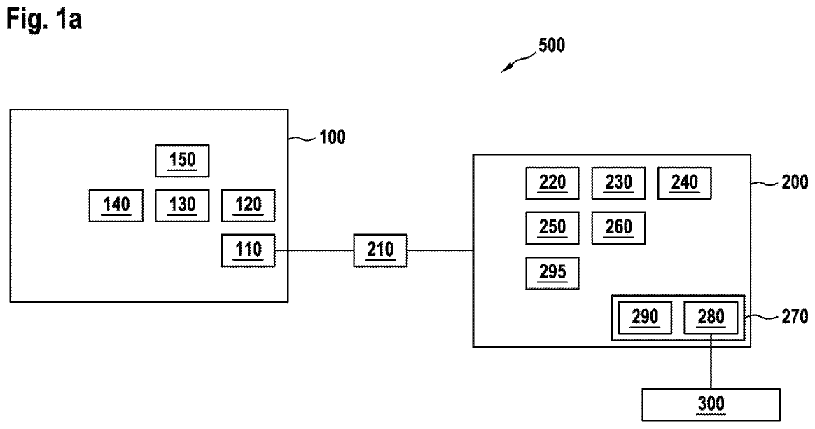

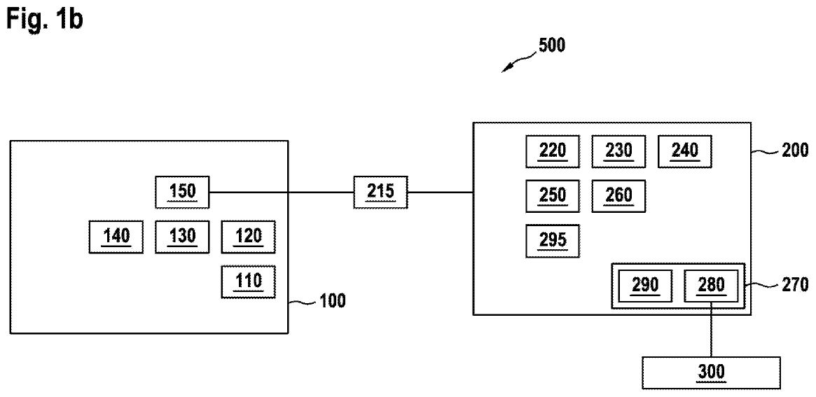

FIG. 1a shows a battery discharging system 500 according to the invention according to a first embodiment of the present invention. The battery discharging system 500 comprises a battery 130, in particular a drive or traction battery, in a unit comprising the battery 130, which is configured here as an electric vehicle 100, for example. Furthermore, the battery discharging system 500 comprises a mobile discharging device 200 for the targeted controlled discharging of the battery 130, which is connected to the electric vehicle 100 via a connecting cable 210, in particular a charging cable.

For this purpose, the mobile discharging device 200 comprises a connection, which is not explicitly shown, via which the connecting cable 210 can be connected, for example plugged in. Alternatively, the connecting cable 210 is fixedly connected to the discharging device 200. Furthermore, the mobile discharging device 200 includes a transmission means 230 for sending and receiving signals, an evaluation device 220 comprising intelligent evaluation electronics and at least one integrated storage medium, wherein the intelligent evaluation electronics are configured to decrypt and interpret a signal.

For example, the evaluation means 220 also includes means for enabling transmission of information regarding the unit 100 comprising the battery 130. Such information is, for example, a location, in particular a GPS location and/or a chassis number.

Furthermore, the discharging device 200 comprises a power supply 240, an internal power receiver 250, and a control device 260 for the drawn power, in particular as overload protection.

The discharging device 200 also comprises an internal cooling means 270. The cooling device 270 can be connected to an external unit 300 comprising a cooling medium via a cooling device connection 280. For example, the cooling medium is water. The unit 300 comprising the cooling medium is, for example, a rescue vehicle, a water hydrant, or a water line, in particular a standard household one. In addition, the cooling device 270 includes a temperature-controlled flow control 290.

Furthermore, the mobile discharging device 200 comprises a display device 295 that indicates a discharge state and/or a charge state and/or a battery voltage and/or a temperature of the battery to be discharged and/or a cooling water temperature. Alternatively or additionally, the display device 295 comprises a signal light.

In addition to the battery 130, the electric vehicle 100 comprises other live components 150, a control unit 120, an on-board computer 140, and a charging socket 110 as a connection point. For example, a connecting cable 210, in particular a charging cable of the electric vehicle 100, can be inserted into the charging socket 110 so that energy from the battery 130 can be transferred to the mobile discharging device 200 via the connecting cable 210.

After the mobile discharging device 200 is connected to the charging socket 110 of the electric vehicle 100 via the connecting cable 210, a connection between the electric vehicle and the discharging device is detected by the control unit 120 of the electric vehicle 100 and by the intelligent evaluation electronics of the evaluation device 220 of the mobile discharging device 200 by detecting a signal. The detected signal is, for example, a dataset from a device, in particular the control unit 120 of the electric vehicle 100.

The detected connection initiates communication with the control unit 120 of the electric vehicle 100, and the intelligent electronics of the evaluation device 220 of the discharging device 200 specify to the control unit 120 of the electric vehicle 100 that energy should be drawn from the battery 130. For this purpose, the intelligent evaluation electronics of the evaluation device 220 simulate to the control unit 120 of the electric vehicle 100, for example, that power should be fed back into a power grid.

Communication between the control unit 120 of the electric vehicle 100 and the evaluation device 220 of the discharging device 200 is then ended, and discharging of the battery 130 of the electric vehicle 100 begins. Here, energy is drawn from the battery 130 of the electric vehicle 100 and supplied to the energy consumer 250 of the mobile discharging device 200.

The discharging device 200 is cooled during the discharging process of the battery 130 via a cooling device 270, for example, by means of a cooling medium, such as water, supplied externally via a cooling device connection 280. A temperature-controlled flow regulation 290 is used, for example, to control and/or regulate the cooling medium's inflow and/or the speed at which the cooling medium circulates. In addition, the temperature-controlled flow regulation 290 and the evaluation device 220 of the discharging device communicate with each other, for example, so that adjustments to the discharge rate of the battery 130 can be made if necessary.

Discharging of the battery 130 is ended or paused when a predetermined threshold value of the discharge state and/or charge state, for example 10%, and/or voltage value and/or temperature value of the battery 130 to be discharged is reached.

Before, during, and/or after the discharge process, for example, state information of the battery 130 and/or individual battery cells of the battery, such as a discharge state and/or a charge state and/or a voltage value and/or a discharge capacity and/or an energy output and/or a thermal state of the battery 130, in particular a temperature of the battery 130, is transmitted from the evaluation device 220 of the discharging device 200 to the electric vehicle 100 and/or to a further receivers. This transmission is carried out, for example, at arbitrarily adjustable intervals during the discharge process.

Furthermore, for example, information about the electric vehicle 100, in particular its location and/or chassis number, is sent via a radio network to a receiver, such as a terminal device of a service technician at a workshop or emergency services at an accident site.

FIG. 1b shows a battery discharging system 500 according to the invention according to a second embodiment of the present invention. This differs from the embodiment described in FIG. 1a in that the connection point of the electric vehicle 100 is a live component 150, for example a high-voltage component of the electric vehicle 100. The connecting cable 215 has a suitable option to connect to the live component of the electric vehicle 100. This is used, for example, when the charging socket 110 of the electric vehicle 100 is no longer usable due to damage, or the electric vehicle 100 is not designed for bidirectional current flow, or when it is a single battery, for example, in a store.

The live component 150, in particular the high-voltage component, is connected to the discharging device 200 via the suitable connection option of the connecting cable 215, so that energy from the battery 130 of the electric vehicle 100 can be transferred to the mobile discharging device 200 via the connecting cable 215.

The intelligent evaluation electronics of the evaluation device 220 of the mobile discharging device 200 detect the connection between the electric vehicle 100 and the mobile discharging device 200 by detecting a signal. This signal is, for example, a voltage value, in particular of a high-voltage line, or a change in the voltage value of the live component. As a result, the intelligent evaluation electronics of the evaluation unit 220 of the discharging device 200 start discharging the battery 130 of the electric vehicle 100 automatically or after approval from an operator. When discharging the battery 130, energy is drawn from it and supplied to the energy consumer 250 of the mobile discharging device 200.

Apart from the distinguishing features described here, the features described for FIG. 1a also apply to this embodiment.

1. A mobile discharging device (200) for the targeted controlled discharging of a battery (130) of a unit (100), in an electric vehicle or a second-life application, comprising the following components
a connection,
a transmission device (230) for sending and receiving signals,
an evaluation device (220) comprising intelligent evaluation electronics and at least one integrated storage medium, wherein the intelligent evaluation electronics are configured to decrypt and interpret a signal,
an energy supply (240),
an internal energy consumer (250), and
a control device (260) for the drawn energy as overload protection.

2. The mobile discharging device (200) according to claim 1, wherein the discharging device further comprises an internal cooling device (270) for cooling by means of air and/or a liquid cooling medium, and wherein the cooling medium can circulate within a circuit and/or can be externally connected via a cooling device connection (280).

3. The mobile discharging device (200) according to claim 2, wherein the cooling device (270) comprises a temperature-controlled flow control (290).

4. The mobile discharging device (200) according to claim 1, wherein the mobile discharging device (200) comprises a display device (295) via which a discharge state and/or a charge state and/or a battery voltage and/or a temperature of the battery to be discharged and/or a cooling water temperature and/or a signal light can be displayed.

5. The mobile discharging device (200) according to claim 1, wherein the evaluation device (220) comprises a means for enabling transmission of information regarding the battery and/or the unit (100) comprising the battery.

6. A method for targeted controlled on-site discharging of a battery (130) of a unit (100) comprising said battery, in an electric vehicle or a second-life application, using a mobile discharging device (200) according to claim 1, comprising the following steps:
a) Connecting the connection of the mobile discharging device (200) to the connection point (110, 150) of the unit (100) comprising the battery (130) to be discharged via a connecting cable (210, 215).
b) Detecting a connection between the unit (100) comprising the battery (130) and the mobile discharging device (200) at least by means of the intelligent evaluation electronics of the evaluation device (220) of the mobile discharging device (200) by detecting a signal.
c) Discharging the battery (130) of the unit (100), wherein energy is drawn from the battery (130) and supplied to the mobile discharging device (200).

7. The method according to claim 6, wherein before, during, or after step a) or step b), a cooling medium for a cooling device (270) of the discharging device (200) is additionally connected via a cooling device connection (280).

8. The method according to claim 6, wherein the connection point of the unit (100) comprising the battery (130) is a charging socket (110).

9. The method according to claim 6, wherein in step b), the detection of the connection between the unit (100) comprising the battery (130) and the mobile discharging device (200) is also recognized by the control unit (120) of the unit (100) comprising the battery (130).

10. The method according to claim 9, wherein step b) is followed by subsequent step b′)
b′) initiating communication with the control unit (120) of the unit (100) comprising the battery (130) by means of the detected connection, and specifying by means of the intelligent electronics of the evaluation device (220) of the discharging device (200) to the control unit (120) of the unit (100) comprising the battery (130) that energy should be drawn from the battery (130), by simulating or initiating an internal vehicle routine that power should be fed back into a power supply system.

11. The method according to claim 10, wherein step b′) is followed by subsequent step b″)
b″) ending communication between the control unit (120) of the unit (100) comprising the battery and the evaluation device (220) of the discharging device (200).

12. The method according to claim 6, wherein the connection point of the unit (100) comprising the battery (130) is a live component (150).

13. The method according to claim 6, wherein the signal in step b) is a voltage value of a high-voltage line or a change of the voltage value of the voltage-carrying component.

14. The method according to claim 6, wherein in step c), the intelligent evaluation electronics of the evaluation unit (220) of the discharging device (200) automatically starts discharging the battery (130) after detection of the connection to the unit (100) comprising the battery (130) or after approval from an operator.

15. The method according to claim 6, wherein state information of the battery (130) and/or individual battery cells of the battery (130), such as a discharge state and/or a charge state and/or a voltage value and/or a discharge capacity and/or an energy output and/or a thermal state of the battery (130) is transmitted from the evaluation device (220) of the discharging device (200) to the unit (100) comprising the battery (130) and/or to other receivers.

16. The method according to claim 15, wherein the state information of the battery (130) and/or the battery cells is transmitted at arbitrarily adjustable intervals during the discharge process.

17. The method according to claim 6, wherein location information of the unit (100) comprising the battery (130) and/or when the unit (100) comprising the battery (130) is an electric vehicle, its chassis number, is sent to a mobile device.

18. The method according to claim 15, the information of the unit 100 comprising the battery or state information of the battery (130)and/or individual battery cells of the battery (130) is transmitted via a radio network.

19. The method according to claim 6, wherein the discharge in step c) is ended or paused when a predetermined threshold value of the discharge state and/or charge state and/or voltage value and/or temperature value of the battery (130) to be discharged is reached.

20. A battery discharge system comprising a battery (130) in a unit (100) comprising said battery and further comprising a mobile discharging device (200), wherein the unit (100) comprising the battery (130) and the discharging device (200) are connectable to each other via a connecting cable (210, 215), such that electrical energy is transferable from the battery (130) to the discharging device (200) by means of a method according to claim 6.
